(19) United States
(12) Patent Application Publication
(10) Pub. No.: US 2003/0135353 A1
(43) Pub. Date: Jul. 17, 2003

(54) User-executable method for complex model data analysis and associated system, computer device, and computer software program product

(75) Inventors: Marc R. Houyoux, Raleigh, NC (US); Sousan Karimi, Raleigh, NC (US); Karen M. Litwin, Raleigh, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: MCNC

(21) Appl. No.: 10/044,316

(22) Filed: Jan. 11, 2002

(51) Int. Cl. G06F 17/60

(52) U.S. Cl. 703/2; 705/1

(57) ABSTRACT

A method for providing a cost quote for a complex model data analysis is provided, wherein the analysis is performed on a computer device remotely disposed with respect to a computer terminal adapted to be used by a user. First, the user at the remote computer terminal is prompted to select an input data and an analysis parameter for an analysis of the data input according to a complex model. An automated cost calculator function is then executed in response to the selected input data and analysis parameter, wherein the cost calculator function is particularly configured with respect to the complex model so as to provide a cost quote for execution of the corresponding analysis by the computer device. The cost quote is thereafter provided to the user at the remote computer terminal. In some instances, the user is then capable of modifying the input data and the analysis parameter and resubmitting the modified input data and analysis parameter so as to obtain a corresponding revised cost quote for the respective analysis. Once the input data and analysis parameter are selected, the analysis is executed according to the complex model for the selected input data and analysis parameter at the computer device so as to determine a result. The result of the analysis and a billing corresponding to the cost quote are then provided to the user. An associated computer software program product, computer device, and system are also provided.

### BACKGROUND OF THE INVENTION

The present invention relates to complex model data analysis and, more particularly to a user-executable method for complex model data analysis and associated system, computer device, and computer software program product.

Some computer-implemented models, for a variety of reasons, may only be executed by a proprietor on a designated computer system. For example, the model, even though open-source, may be so complex and may require such voluminous computations that a high capacity computer system is required in order to execute the model. Such high capacity computer systems, however, may be beyond the reach of many users needing to use such a model due to financial or space and upkeep considerations. In other instances, the proprietor may wish to closely hold the model in order to protect proprietary rights in the software. In still other instances, the input data and/or the results of the model may require trained analysis in order to provide valid and meaningful results. Thus, in such instances, the user may often be required to approach a third party proprietor of such a model in order to have a set of data executed according to that model so as to obtain the desired results.

Submitting a data set for execution according to the desired model may often be a significant undertaking for both the user and the proprietor. For example, the data may be transmitted between the parties by physical electronic storage media or even on paper, where the data must then be accessed, translated and/or entered in a format suitable for use by the model. Only then can the proprietor provide a cost estimate to the user associated with the execution of the model with that data. However, if the estimated cost is outside the budget of the user, the user may have to modify the data and resubmit the modified data for a revised cost estimate. This process may often require several iterations in order to attain acceptable analysis terms and costs for the user. A significant amount of time may also elapse after the initial query by the user due the iterative approach necessary before obtaining satisfactory terms for the user. A further limitation in such an iterative approach is that the data handling and cost estimation service often requires the proprietor to designate trained manpower for interacting with the user, which increases the cost to the proprietor for providing the analysis service. Still further, even with trained personnel, the user may be provided with inconsistent estimates where subjective elements are involved in the determination of the data analysis costs.

Thus, there exists a need for a system for allowing the user of a complex model to submit input data and analysis parameters to the proprietor of the model and to obtain an expedient and consistent cost quote for execution of the model with the particular data and analysis parameters. Such a system should also allow the user to readily modify the terms and obtain revised cost quotes therefor in an expedient manner. For the proprietor, such a system should provide for interaction with the user with minimal or no required involvement of trained personnel designated and assigned by the proprietor, thereby reducing the costs of the proprietor in providing the associated analysis services. In addition, such a system should be sufficiently flexible and adaptable so as to readily support related models which may be desirable for providing the user with additional analysis capabilities.

### BRIEF SUMMARY OF THE INVENTION

The above and other needs are met by the present invention which, in one embodiment, provides a method for providing a cost quote for a complex model data analysis, wherein the analysis is performed on a computer device remotely disposed with respect to a computer terminal adapted to be used by a user. First, the user at the remote computer terminal is prompted to select an input data and an analysis parameter for an analysis of the data input according to a complex model. An automated cost calculator function is then executed in response to the selected input data and analysis parameter, wherein the cost calculator function is particularly configured with respect to the complex model so as to provide a cost quote for execution of the corresponding analysis by the computer device. The cost quote is thereafter provided to the user at the remote computer terminal. In some instances, the user is then capable of modifying the input data and the analysis parameter and resubmitting the modified input data and analysis parameter so as to obtain a corresponding revised cost quote for the respective analysis. Once the input data and analysis parameter are selected, the analysis is executed according to the complex model for the selected input data and analysis parameter at the computer device. A result of the analysis and a billing corresponding to the cost quote are then provided to the user.

According to other advantageous aspects of the present invention, a computer software program product may be implemented, the computer software program product having a plurality of executable portions capable of executing each of the various methods as disclosed herein. Accordingly, a further advantageous aspect of the present invention comprises a computer device having a plurality of processing portions configured to implement each of the various methods as disclosed herein. Still another advantageous aspect of the present invention comprises a system of intercommunicable components capable of accomplishing each of the various methods as disclosed herein, such a system comprising, for example, a data generation module, a cost calculator module, a model execution module, and a server module. Such advantageous aspects of the present invention may be accomplished through hardware, software, or a combination of hardware and software as will be appreciated by one skilled in the art as being within the spirit and scope of the present invention.

Thus, embodiments of the present invention provide a method, computer software program product, computer device, and system for allowing the user of a complex model to submit input data and analysis parameters to the proprietor of the model and to obtain an expedient and consistent cost quote for execution of the model with the particular input data and analysis parameters. Embodiments of the present invention also allow the user to readily modify the input data and analysis parameter terms and to obtain revised cost quotes corresponding thereto in an expedient manner. For the proprietor, embodiments of the present invention also provide for interaction with the user with minimal or no required involvement of trained personnel designated and assigned by the proprietor for handling such a task, thereby reducing the costs of the proprietor in providing the associated analysis services as described herein. In addition, embodiments of the present invention provide a method, computer software program product, computer device, and system which are sufficiently flexible and adaptable so as to readily support related models, which may be desirable for providing the user with additional analysis capabilities. As such, embodiments of the present invention provide significant advantages as will be described further herein.

### BRIEF DESCRIPTION OF THE SEVERAL VIEWS OF THE DRAWINGS

Having thus described the invention in general terms, reference will now be made to the accompanying drawings, wherein:

FIG. 1 is a schematic illustration of a system capable of implementing a user-executed method for complex model data analysis according to one embodiment of the present invention.

FIG. 2 is a flowchart illustrating a method of providing a cost quote for a complex model data analysis according to one embodiment of the present invention.

FIG. 3 is a flowchart illustrating a method of complex model data analysis according to one embodiment of the present invention.

### DETAILED DESCRIPTION OF THE INTENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

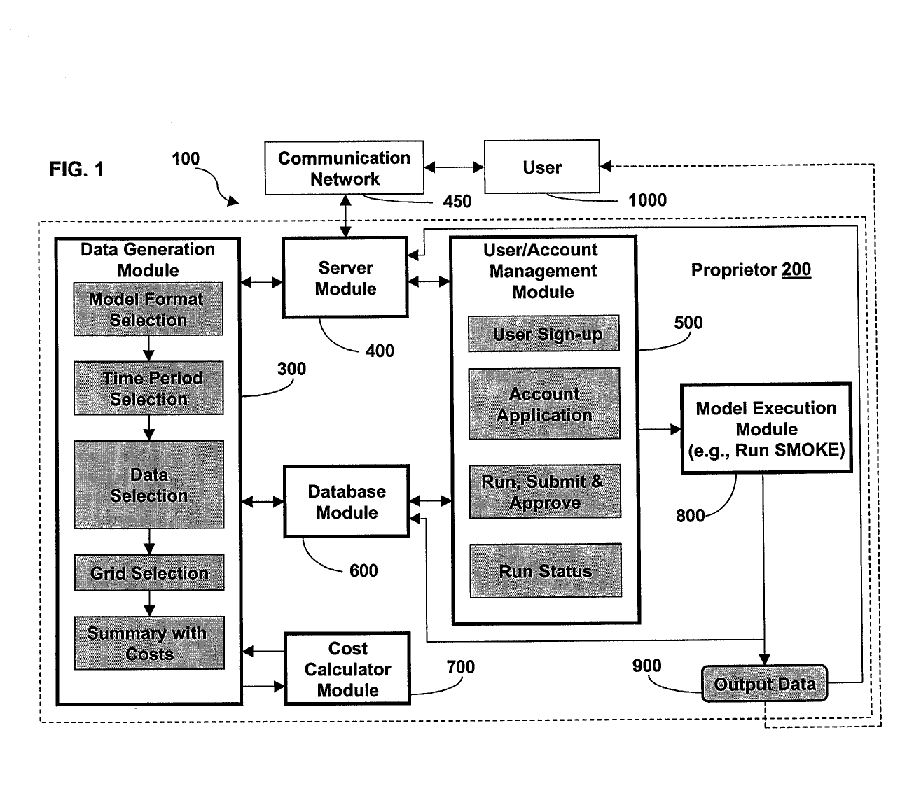

FIG. 1 schematically illustrates a system corresponding to user-executed method for complex model data analysis according to one embodiment of the present invention, the system being indicated generally by the numeral 100. The system 100 is generally implemented by a proprietor 200 and comprises a data generation module 300 made available via a server device 400 and managed by a user/account management module 500. The system 100 further includes a database module 600, a cost calculator module 700, and a model execution module 800. The components of the system 100 thus cooperate to produce output data which may be supplied by an output module 900 to a user 1000. Note that the database module 600, cost calculator module 700, model execution module 800, and output module 900 are generally implemented in computer software, though these components may be implemented in a combination of software and hardware in some instances. Note also that a system, method, computer software program product, and computer device according to embodiments of the present invention are described herein using the example of an environmental model. However, one skilled in the art will appreciate that the concepts described herein are not limited to environmental models, but may also be applicable to other situations in which complex or proprietary models are involved such as, for example, in finite element or dynamic analyses.

The system 100, according to one embodiment, is configured to function over a large network such as, for example, the Internet or World Wide Web, as will be appreciated by one skilled in the art. However, such a system 100 may also be configured for use in an intranet or other closely held network, where necessary. Accordingly, the system 100 may be implemented on a computer device (not shown) by the proprietor 200 such that the data generation module 300 and, in some instances, the user/account management module 500, are accessible to the user 1000 at a computer terminal (not shown) over a communication network 450 via the server module 400. The communication network 450 may comprise, for example, the Internet, while the data generation module 300 and the user/account management module 500 are generally implemented in computer software, though these components may also, in some cases, be implemented in a combination of software and hardware. The computer terminal used by the user 1000 is generally remotely disposed with respect to the computer device implementing the system 100 so as to facilitate the convenience of both the user 1000 and the proprietor 200. For example, such a configuration allows the user 1000 to access and use the system 100, essentially on demand, without requiring the active involvement of the proprietor 200. Thus, the user 1000 may access the data generation module 300 and/or the user/account management module 500 through, for example, a graphical user interface or other appropriate presentation, at the computer terminal.

Note that the data generation module 300, the user-account management module 500, and/or the cost calculator module 700 may be implemented on the server module 400, a switching device, a router device, a mainframe computer device, or combinations thereof, or any hardware or combination of software and hardware necessary to provide the functions and methods as detailed herein and as will be appreciated by one skilled in the art. In addition, the model execution module 800 and/or the database module 600 may be implemented in conjunction with the other modules or may alternatively be implemented on a separate and dedicated computer device, such as a mainframe computer, supercomputer, or other device comprising appropriate hardware or a combination of hardware and software for performing the described analyses, functions, and methods. Note also that, while the system 100 is described herein in terms of a single user 1000 at a computer terminal connected to the computer network 450, it is understood that this concept is representative of communication through, for example, an Internet site on, for instance, the World Wide Web, and may involve many different computers and associated equipment, wherein the concept of communication via the Internet is known to one skilled in the art. Thus, implementation of such a system 100 in this manner provides significant benefits both to the user 1000 such as, for example, instant access to cost, data, and model updates, and on-demand cost quotes, and to the proprietor 200 such as, for example, lower manpower expenditures, higher cost effectiveness, and more consistent and accurate administration.

As further shown in FIG. 1, interaction by the user 1000 with the system 100 is initiated through the establishment of an appropriate account with the user/account management module 500. Such an account may indicate, for example, the billing information for the user 1000, the terms of the account, data set and analysis model access authorizations, ongoing or completed analyses, or any other information consistent with establishing the identity of the user 1000 and status thereof with respect to the system 100. Once the user 1000 has established an appropriate account, the user 1000 may then access the data generation module 300, which may further comprise, for example, provisions for defining the appropriate data and the parameters according to which the data is analyzed. For example, the user 1000 may select the desired type of modeling, wherein such modeling types may include a global model type, such as the Global Balance Environment (GLOBE) modeling system, or a regional/urban model type, such as that provided by the Sparse Matrix Operator Kernel Emissions (SMOKE) modeling system. The SMOKE modeling system is a model type particularly directed to air quality and emissions modeling and may implement specific air quality models such as, for example, a Community Multiscale Air Quality (CMAQ) model, an Urban Airshed Model—Variable Grid (UAM-V) model, a Comprehensive Air Quality Model with Extensions (CAMx) model, a Multiscale Air Quality Simulation Platform (MAQSIP) model, a Regulatory Modeling System for Aerosols and Deposition (REMSAD) model, an Urban Airshed Model—Aerosol (UAM-AERO) model, and an Urban Airshed Model—Version 4 (UAM-IV) model. One skilled in the art will appreciate, however, that the list of specific air quality models described herein are for exemplary purposes only and are not meant to be limiting as other such air quality and emissions models may already exist or be developed in the future which may be equally applicable with respect to the system 100 and the SMOKE model type described herein.

Once the model type and specific model have been selected, other defining parameters and the applicable data must also be selected by the user 1000. For example, within the scope of the exemplary air quality models described, any applicable speciation may be selected, along with a grid, appropriate dates, source categories (such as, for example, optional selections of area sources, point sources, biogenics sources, and mobile sources), and a number of emission layers, or the like. The data and analysis parameter selections required by the data generation module 300 may be supplied by the user 1000. However, in some instances, the necessary data and/or analysis parameters may be obtained from the database module 600. In other instances, some portions of data and analysis parameters may be supplied by the user 1000 and combined with subsequent portions of data and analysis parameters from the database module 600. The data and/or analysis parameters obtained from the database module 600 may be generally available to users 1000 of the system 100 or may identified as accessible to a particular user 1000 through the corresponding account for that user 1000 established in the user/account management module 500. These model types and specific air quality models may be, for example, proprietary or, in some instances, open-source. However, even though the specific air quality model may be open-source, such a model may be very complex, requiring specialized or otherwise extensive computing capabilities not routinely accessible to the user 1000. Accordingly, once the applicable data and analysis parameters for such models are developed, the corresponding analysis is generally conducted on a proprietor's computer device by the model execution module 800 as a batch process or in another appropriate processing configuration. Note also that, in instances involving an environmental model, the nature of the data and analysis parameters necessary for defining an analysis according to the model may be significantly complex. In such instances, the data generation module 300 may include a wizard function, as will be understood and appreciated by one skilled in the art as providing an evaluation mechanism for the user 1000, wherein interactions therebetween are configured to determine if the system 100 is capable of meeting the needs of the user 1000 and, if so, to solicit the necessary information from the user 1000 so as to form the appropriate combination of data and analysis parameters for obtaining the desired analysis. Thus, the configuration of the data generation module 300 provides simplified options for an inexperienced user as well as extensive flexibility in analysis configuration for an experienced user.

An important advantageous aspect of the present invention comprises the cost calculator module 700, which is particularly configured to generate a cost quote based at least partially on the data and analysis parameters selected by the user 1000. Generally, the selections made by the user 1000 through the data selection module 300 each have a cost factor associated therewith which comprise at least a portion of the cost quote. For example, the specific model(s), applicable dates, and grid size and layers, as well as any uploaded data and/or data stored within the database module 600 selected for the analysis can be combined to determine the size of the data set to be analyzed and an associated cost determined on, for instance, a per GB basis. Accordingly, the amount of time necessary for running the analysis on the model execution module 800 of the proprietor's computer device may be determined from the size of the data set and the selected analysis parameters. However, other factors may also be considered in order to determine and provide a consistent cost quote inclusive of the actual costs associated with running an analysis with the system 100. For example, a cost may be associated with storing data sets and/or analysis results for the user 1000 in the database module 600, and any manpower (labor and benefits), overhead, or other resources provided by the proprietor 200 for system administration, debugging of input data and analysis parameters, technical assistance, and database administration may also be assigned fixed or variable costs. The file size of the results, the selected method of delivery of the results to the user 1000, and the level of assessment provided by the proprietor 200 with respect to the results may also be included in the cost quote, along with various distributed costs and/or fees such as, for example, system maintenance and repair costs. However, the cost quote may also reflect discounts for the user 1000 in terms of, for example, repeat use of the system 100, limited data set size or data set re-use, or other specific agreement provisions. The cost quote resulting from the particular automated assessment of the data and analysis parameters selected by the user 1000 may then be provided to the user 1000 at the remote computer terminal, or in any other form selected by the user 1000, with the cost quote including as much or as little detail in the calculation of the cost quote as desired to be provided by the proprietor 200. Note that such functions as associated with the cost calculator module 700 importantly serve to provide a user 1000 with heretofore unavailable timeliness and consistency by providing an automated and essentially on-demand cost quote system and thereby eliminating time delays and cost variations associated with human performance of such functions for the execution of a complex model data analysis.

Once the selected analysis is executed by the computer device, the results are made available from the output module 900 to the user 1000 under appropriate terms selected thereby. For example, the results may be provided from the output module 900 to the user 1000 through the graphical user interface or other mechanism at the computer terminal used to access the data generation module 300 and the user/account management module 500. However, the output module 900 may also direct the results to be provided, for instance, via the physical delivery of an electronic storage media device such as a hard disk, digital audio tape (DAT), digital linear tape (DLT), or the like. In still other instances, the results may be electronically transferred from the output module 900 to the user 1000 such as by, for example, a file transfer protocol (FTP) process over the communication network 450 via the server device 400, or the output module 900 may direct the results to be physically sent as a paper or other hard copy through the mail or by other delivery services. According to some embodiments of the present invention, the proprietor 200 may also provide an assessment of the results of the analysis to the user 1000. Such an assessment may, for example, provide a novice user with readily usable evaluation information, in addition to the actual analysis results, or provide a repeat user with a consistent trained evaluation of the analysis results. In any instance, the data and analysis parameters, as well as the analysis results, may be stored according to the user account information in a database administered by the database module 600, wherein the user 1000 may designate any or all subsequent use of the data, analysis parameters, and/or analysis results as, for example, for private use by the user 1000 only, for use by a designated group of users, or for public use. Accordingly, through the user/account management module 500, the user 1000 may also have access to information regarding past analyses, data sets, and subsequent users of the saved, or any other appropriate information in this regard.

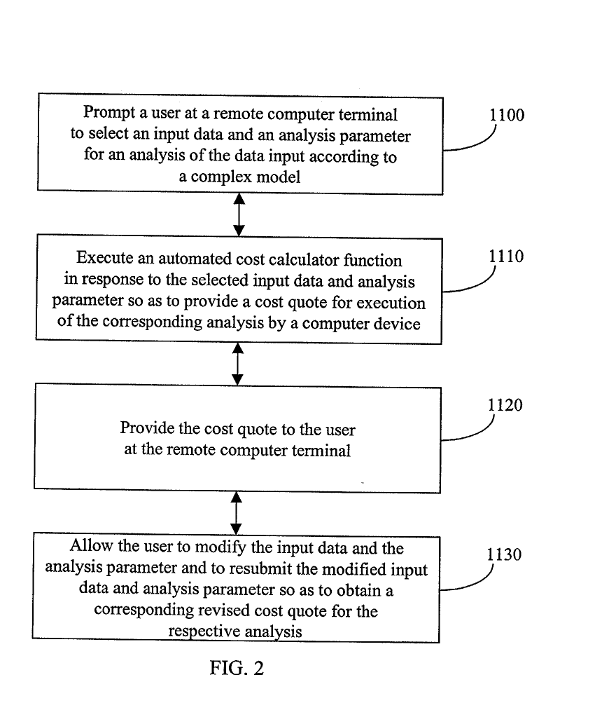

The system 100 as described above may also be embodied in an associated method, computer software program product, and computer device within the spirit and scope of the present invention. For example, in an appropriately basic form as shown in FIG. 2, the system 100 supports a method of providing a cost quote for a complex model data analysis performed on a computer device being remotely disposed with respect to a computer terminal adapted to be used by a user. The user at the remote computer terminal is first prompted to select an input data and an analysis parameter for an analysis of the data input according to a complex model (Block 1100). An automated cost calculator function is then executed (Block 1110) in response to the selected input data and analysis parameter, wherein the cost calculator function is particularly configured with respect to the complex model so as to provide a cost quote for execution of the corresponding analysis by the computer device. The resulting cost quote is then provided to the user at the remote computer terminal (Block 1120). However, the user is thereafter being capable of modifying the input data and the analysis parameter and resubmitting the modified input data and analysis parameter so as to obtain a corresponding revised cost quote for the respective analysis (Block 1130).

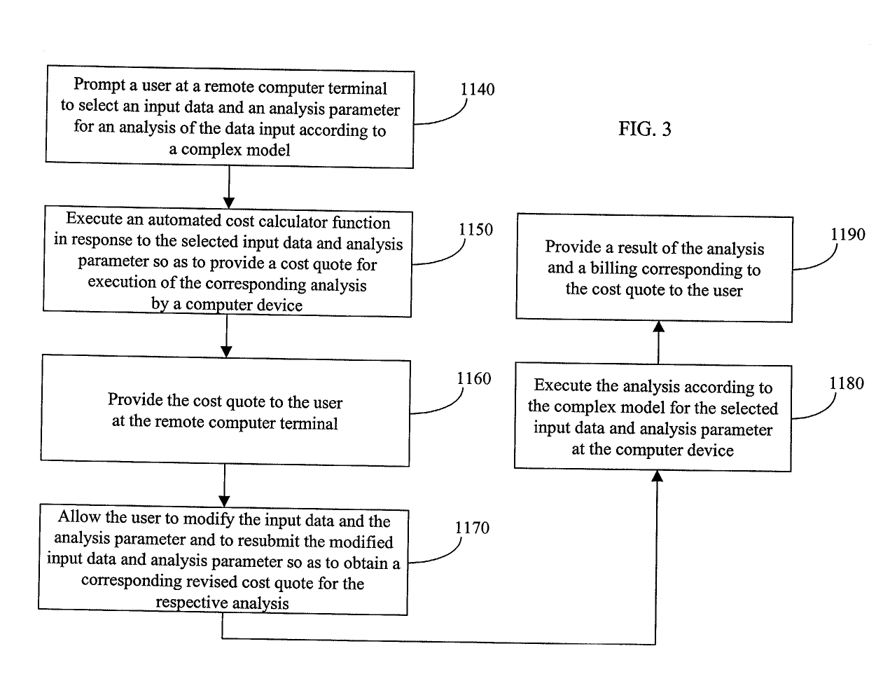

In a more extensive form as shown in FIG. 3, the system 100 further supports a method for complex model data analysis. Due to the complexity of the particular model, requiring specialized or extensive computing capabilities, or the proprietary nature of the model, the analysis of the data is performed on a computer device remotely disposed with respect to a computer terminal used by the user. The user at the remote computer terminal is prompted to select an input data and an analysis parameter for an analysis of the input data according to the complex model (Block 1140). An automated cost calculator function is then executed in response to the selected input data and analysis parameter (Block 1150). The cost calculator function is particularly configured with respect to the complex model so as to provide a cost quote for execution of the corresponding analysis by the computer device. The resulting cost quote is then provided to the user at the remote computer terminal (Block 1160). The user is thereafter being capable of modifying the input data and the analysis parameter and resubmitting the modified input data and analysis parameter so as to obtain a corresponding revised cost quote for the respective analysis (Block 1170). When the user has obtained an acceptable cost quote, the analysis is executed by the computer device according to the complex model for the selected input data and analysis parameter (Block 1180). The results of the analysis and a billing corresponding to the cost quote are thereafter provided to the user (Block 1190), in some instances at the remote computer terminal.

As will be appreciated by one skilled in the art, embodiments of a system and associated methods as described herein readily support an appropriate computer software program product having a plurality of executable portions capable of implementing the important functionality of such systems and methods, as well as an appropriate computer device having one or more processing portions configured to accomplish the same, wherein one skilled in the art will appreciate that such executable portions and processing portions may be implemented in software or a combination of software and hardware according to the present invention. Thus, for the sake of brevity, such details will not be further addressed herein, but will be considered to be supported by the provided disclosure and within the spirit and scope of the present invention.

Thus, embodiments of the present invention provide a method, computer software program product, computer device, and system for allowing the user of a complex model to submit input data and analysis parameters to the proprietor of the model and to obtain an expedient and consistent cost quote for execution of the model with the particular input data and analysis parameters. Embodiments of the present invention also allow the user to readily modify the input data and analysis parameter terms and to obtain revised cost quotes corresponding thereto in an expedient manner. For the proprietor, embodiments of the present invention also provide for interaction with the user with minimal or no required involvement of trained personnel designated and assigned by the proprietor for handling such a task, thereby reducing the costs of the proprietor in providing the associated analysis services as described herein. In addition, embodiments of the present invention provide a method, computer software program product, computer device, and system which are sufficiently flexible and adaptable so as to readily support related models, which may be desirable for providing the user with additional analysis capabilities.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for providing a cost quote for a complex model data analysis, the analysis being performed on a computer device being remotely disposed with respect to a computer terminal adapted to be used by a user, said method comprising:
prompting the user at the remote computer terminal to select an input data and an analysis parameter for an analysis of the data input according to a complex model;
executing an automated cost calculator function in response to the selected input data and analysis parameter, the cost calculator function being particularly configured with respect to the complex model so as to provide a cost quote for execution of the corresponding analysis by the computer device; and
providing the cost quote to the user at the remote computer terminal, the user thereafter being capable of modifying the input data and the analysis parameter and resubmitting the modified input data and analysis parameter so as to obtain a corresponding revised cost quote for the respective analysis.

2. A method according to claim 1 further comprising executing the analysis according to the complex model for the selected input data and analysis parameter at the computer device after executing the automated cost calculator function.

3. A method according to claim 2 further comprising providing a result of the analysis and a billing corresponding to the cost quote to the user after executing the analysis according to the complex model.

4. A method according to claim 3 further comprising providing at least one of the result of the analysis and the billing corresponding to the cost quote to the user at the remote computer terminal.

5. A method according to claim 1 further comprising establishing an account for the user prior to prompting the user to select an input data and an analysis parameter.

6. A method according to claim 2 further comprising retrieving the selected input data and analysis parameter from a database prior to executing the analysis according to the complex model.

7. A method according to claim 3 further comprising storing at least one of the result of the analysis and the billing corresponding to the cost quote in a database after executing the analysis according to the complex model.

8. A method according to claim 5 further comprising storing at least one of the selected input data, the selected analysis parameter, the result of the analysis, and the billing corresponding to the cost quote in a database according to the account for the user.

9. A method according to claim 1 wherein prompting the user to select an input data further comprises prompting the user to select an input data for a complex environmental model, the input data comprising at least one of a date span, a grid, an area source, a point source, a biogenics source, a mobile source, an all merge option, a meteorology option, and a maximum number of emission layers for the meteorology option.

10. A method according to claim 1 wherein prompting the user to select an analysis parameter further comprises prompting the user to select an analysis parameter for a complex environmental model, the analysis parameter comprising at least one of a modeling type, a particular model within the modeling type, and a speciation of the particular model.

11. A method according to claim 10 wherein prompting the user to select an analysis parameter for a complex environmental model further comprises prompting the user to select a modeling type comprising at least one of a global modeling type and a regional/urban modeling type.

12. A method according to claim 11 wherein prompting the user to select an analysis parameter for a complex environmental model further comprises prompting the user to select a modeling type comprising at least one of a Global Balance Environment (GLOBE) global modeling type and a Sparse Matrix Operator Kernel Emissions (SMOKE) regional/urban modeling type.

13. A method according to claim 12 wherein prompting the user to select an analysis parameter for a complex environmental model further comprises prompting the user to select a particular model within the SMOKE regional/urban modeling type, the particular model comprising at least one of a Community Multiscale Air Quality (CMAQ) model, an Urban Airshed Model—Variable Grid (UAM-V) model, a Comprehensive Air Quality Model with Extensions (CAMx) model, a Multiscale Air Quality Simulation Platform (MAQSIP) model, a Regulatory Modeling System for Aerosols and Deposition (REMSAD) model, an Urban Airshed Model—Aerosol (UAM-AERO) model, and an Urban Airshed Model—Version 4 (UAM-IV) model.

14. A method for complex model data analysis, the analysis being performed on a computer device being remotely disposed with respect to a computer terminal adapted to be used by a user, said method comprising:
prompting the user at the remote computer terminal to select an input data and an analysis parameter for an analysis of the input data according to a complex model;
executing an automated cost calculator function in response to the selected input data and analysis parameter, the cost calculator function being particularly configured with respect to the complex model so as to provide a cost quote for execution of the corresponding analysis by the computer device;
executing the analysis according to the complex model for the selected input data and analysis parameter at the computer device so as to determine a result; and
providing the result of the analysis and a billing corresponding to the cost quote to the user.

15. A method according to claim 14 further comprising establishing an account for the user prior to prompting the user to select an input data and an analysis parameter.

16. A method according to claim 15 further comprising storing at least one of the selected input data, the selected analysis parameter, the result of the analysis, and the billing corresponding to the cost quote in a database according to the account for the user.

17. A method according to claim 14 further comprising providing the cost quote to the user at the remote computer terminal, the user thereafter being capable of modifying the input data and the analysis parameter and resubmitting the modified input data and analysis parameter so as to obtain a corresponding revised cost quote for the respective analysis.

18. A method according to claim 14 further comprising retrieving the selected input data and analysis parameter from a database prior to executing the analysis according to the complex model.

19. A method according to claim 14 wherein prompting the user to select an input data further comprises prompting the user to select an input data for a complex environmental model, the input data comprising at least one of a date span, a grid, an area source, a point source, a biogenics source, a mobile source, an all merge option, a meteorology option, and a maximum number of emission layers for the meteorology option.

20. A method according to claim 14 wherein prompting the user to select an analysis parameter further comprises prompting the user to select an analysis parameter for a complex environmental model, the analysis parameter comprising at least one of a modeling type, a particular model within the modeling type, and a speciation of the particular model.

21. A method according to claim 20 wherein prompting the user to select an analysis parameter for a complex environmental model further comprises prompting the user to select a modeling type comprising at least one of a global modeling type and a regional/urban modeling type.

22. A method according to claim 21 wherein prompting the user to select an analysis parameter for a complex environmental model further comprises prompting the user to select a modeling type comprising at least one of a Global Balance Environment (GLOBE) global modeling type and a Sparse Matrix Operator Kernel Emissions (SMOKE) regional/urban modeling type.

23. A method according to claim 22 wherein prompting the user to select an analysis parameter for a complex environmental model further comprises prompting the user to select a particular model within the SMOKE regional/urban modeling type, the particular model comprising at least one of a Community Multiscale Air Quality (CMAQ) model, an Urban Airshed Model—Variable Grid (UAM-V) model, a Comprehensive Air Quality Model with Extensions (CAMx) model, a Multiscale Air Quality Simulation Platform (MAQSIP) model, a Regulatory Modeling System for Aerosols and Deposition (REMSAD) model, an Urban Airshed Model—Aerosol (UAM-AERO) model, and an Urban Airshed Model—Version 4 (UAM-IV) model.

24. A method according to claim 14 further comprising providing at least one of the result of the analysis and the billing corresponding to the cost quote to the user at the remote computer terminal.

25. A computer software program product being executable on a computer device and being capable of performing a complex model data analysis, the computer device being remotely disposed with respect to a computer terminal adapted for use by a user, said computer software program product comprising:
an executable portion capable of prompting the user at the remote computer terminal to select an input data and an analysis parameter for an analysis of the input data according to a complex model;
an executable portion capable of executing an automated cost calculator function in response to the selected input data and analysis parameter, the executable portion for the cost calculator function being particularly configured with respect to the complex model so as to provide a cost quote for execution of the corresponding analysis by the computer device;
an executable portion capable of executing the analysis, according to the complex model for the selected input data and analysis parameter, at the computer device so as to determine a result; and
an executable portion capable of directing provision of the result of the analysis and a billing corresponding to the cost quote to the user.

26. A computer software program product according to claim 25 further comprising an executable portion capable of establishing an account for the user.

27. A computer software program product according to claim 26 further comprising an executable portion capable of directing the storage of at least one of the input data, the analysis parameter, the result of the analysis, and the billing corresponding to the cost quote in a database according to the account for the user.

28. A computer software program product according to claim 25 further comprising an executable portion capable of directing the provision of the cost quote to the user at the remote computer terminal.

29. A computer software program product according to claim 28 further comprising an executable portion capable of permitting the user to modify the input data and the analysis parameter and resubmitting the modified input data and analysis parameter so as to obtain a corresponding revised cost quote for the respective analysis.

30. A computer software program product according to claim 25 further comprising an executable portion capable of retrieving the selected input data and analysis parameter from a database prior to executing the analysis according to the complex model.

31. A computer software program product according to claim 25 wherein the executable portion capable of prompting the user to select an input data is further capable of prompting the user to select an input data for a complex environmental model, the input data comprising at least one of a date span, a grid, an area source, a point source, a biogenics source, a mobile source, an all merge option, a meteorology option, and a maximum number of emission layers for the meteorology option.

32. A computer software program product according to claim 25 wherein the executable portion capable of prompting the user to select an analysis parameter is further capable of prompting the user to select an analysis parameter for a complex environmental model, the analysis parameter comprising at least one of a modeling type, a particular model within the modeling type, and a speciation of the particular model.

33. A computer software program product according to claim 32 wherein the executable portion capable of prompting the user to select an analysis parameter for a complex environmental model is further capable of prompting the user to select a modeling type comprising at least one of a global modeling type and a regional/urban modeling type.

34. A computer software program product according to claim 33 wherein the executable portion capable of prompting the user to select an analysis parameter for a complex environmental model is further capable of prompting the user to select a modeling type comprising at least one of a Global Balance Environment (GLOBE) global modeling type and a Sparse Matrix Operator Kernel Emissions (SMOKE) regional/urban modeling type.

35. A computer software program product according to claim 34 wherein the executable portion capable of prompting the user to select an analysis parameter for a complex environmental model is further capable of prompting the user to select a particular model within the SMOKE regional/urban modeling type, the particular model comprising at least one of a Community Multiscale Air Quality (CMAQ) model, an Urban Airshed Model—Variable Grid (UAM-V) model, a Comprehensive Air Quality Model with Extensions (CAMx) model, a Multiscale Air Quality Simulation Platform (MAQSIP) model, a Regulatory Modeling System for Aerosols and Deposition (REMSAD) model, an Urban Airshed Model—Aerosol (UAM-AERO) model, and an Urban Airshed Model—Version 4 (UAM-IV) model.

36. A computer software program product according to claim 25 wherein the executable portion capable of directing provision of the result of the analysis and the billing corresponding to the cost quote to the user is further capable of directing provision of at least one of the result of the analysis and the billing corresponding to the cost quote to the user at the remote computer terminal.

37. A computer device configured to perform a complex model data analysis, the computer device being remotely disposed with respect to a computer terminal adapted for use by a user, said computer device comprising:
a processing portion configured to prompt the user at the remote computer terminal to select an input data and an analysis parameter for an analysis of the input data according to a complex model;
a processing portion configured to execute an automated cost calculator function at the remote computer device in response to the selected input data and analysis parameter, the executable portion for the cost calculator function being particularly configured with respect to the complex model so as to provide a cost quote for execution of the corresponding analysis by the computer device;
a processing portion configured to execute the analysis, according to the complex model for the selected input data and analysis parameter, at the computer device so as to determine a result; and
a processing portion configured to direct provision of the result of the analysis and a billing corresponding to the cost quote to the user.

38. A computer device according to claim 37 further comprising a processing portion configured to establish an account for the user.

39. A computer device according to claim 38 further comprising a processing portion configured to store at least one of the input data, the analysis parameter, the result of the analysis, and the billing corresponding to the cost quote in a database according to the user account.

40. A computer device according to claim 37 further comprising a processing portion configured to provide the cost quote to the user at the remote computer terminal.

41. A computer device according to claim 40 further comprising a processing portion configured to permit the user to modify the input data and the analysis parameter and to resubmit the modified input data and analysis parameter so as to obtain a corresponding revised cost quote for the respective analysis.

42. A computer device according to claim 37 further comprising a processing portion configured to retrieve the selected input data and analysis parameter from a database prior to actuation of the processing portion for executing the analysis according to the complex model.

43. A computer device according to claim 37 wherein the processing portion configured to prompt the user to select an input data is further configured to prompt the user to select an input data for a complex environmental model, the input data comprising at least one of a date span, a grid, an area source, a point source, a biogenics source, a mobile source, an all merge option, a meteorology option, and a maximum number of emission layers for the meteorology option.

44. A computer device according to claim 37 wherein the processing portion configured to prompt the user to select an analysis parameter is further configured to prompt the user to select an analysis parameter for a complex environmental model, the analysis parameter comprising at least one of a modeling type, a particular model within the modeling type, and a speciation of the particular model.

45. A computer device according to claim 44 wherein the processing portion configured to prompt the user to select an analysis parameter for a complex environmental model is further configured to prompt the user to select a modeling type comprising at least one of a global modeling type and a regional/urban modeling type.

46. A computer device according to claim 45 wherein the processing portion configured to prompt the user to select an analysis parameter for a complex environmental model is further configured to prompt the user to select a modeling type comprising at least one of a Global Balance Environment (GLOBE) global modeling type and a Sparse Matrix Operator Kernel Emissions (SMOKE) regional/urban modeling type.

47. A computer device according to claim 46 wherein the processing portion configured to prompt the user to select an analysis parameter for a complex environmental model is further configured to prompt the user to select a particular model within the SMOKE regional/urban modeling type, the particular model comprising at least one of a Community Multiscale Air Quality (CMAQ) model, an Urban Airshed Model—Variable Grid (UAM-V) model, a Comprehensive Air Quality Model with Extensions (CAMx) model, a Multiscale Air Quality Simulation Platform (MAQSIP) model, a Regulatory Modeling System for Aerosols and Deposition (REMSAD) model, an Urban Airshed Model—Aerosol (UAM-AERO) model, and an Urban Airshed Model—Version 4 (UAM-IV) model.

48. A computer device according to claim 37 wherein the processing portion configured to direct provision of the result of the analysis and the billing corresponding to the cost quote to the user is further configured to direct provision of at least one of the result of the analysis and the billing corresponding to the cost quote to the user at the remote computer terminal.

49. A system adapted for use by a user over a network and configured to perform a complex model data analysis at a computer device remotely disposed with respect to the user, said system comprising:
a data generation module configured to prompt the user to select an input data and an analysis parameter for an analysis of the input data according to a complex model;
a cost calculator module in communication with the data generation module and particularly configured with respect to the complex model so as to provide a cost quote to the user for execution of the corresponding analysis;
a model execution module configured to execute the analysis according to the complex model for the selected input data and analysis parameter so as to determine a result; and
a server module configured to communicate the selected input data and analysis parameter between the data generation module and the model execution module, the server module being further configured to direct provision of the result of the analysis to the user after being notified of completion of the analysis by the model execution module and to direct provision of a billing to the user corresponding to the cost quote provided by the cost calculator module.

50. A system according to claim 49 further comprising a user/account management module in communication with the server module and the data generation module and configured to establish an account for the user so as to control interaction of the user with the data generation module.

51. A system according to claim 50 further comprising a database module in communication with the data generation module, the user/account management module, and the model execution module and configured to store and manage data associated with the user and the complex model.

52. A system according to claim 51 wherein the model execution module is configured to modify the data in the database module, according to the result of the analysis, upon completion of the analysis.

53. A system according to claim 50 wherein the user/account management module is further configured to control the execution of the analysis by the model execution module according to the account for the user.

54. A system according to claim 50 further comprising a database module in communication with the data generation module, the user/account management module, and the model execution module and configured to store at least one of the input data, the analysis parameter, the result of the analysis, and the billing corresponding to the cost quote in a database according to the user account.

55. A system according to claim 49 wherein the server module is further configured to direct provision of at least one of the cost quote, the result of the analysis, and the billing corresponding to the cost quote to the user at the remote computer terminal.

56. A system according to claim 55 wherein at least one of the data generation module, the cost calculator module, and the server module is configured to permit the user to modify the input data and the analysis parameter and to resubmit the modified input data and analysis parameter to the cost calculator module so as to obtain a corresponding revised cost quote for the respective analysis.

57. A system according to claim 49 wherein the data generation module is further configured to retrieve the selected input data and analysis parameter from a database module prior to model execution module executing the analysis according to the complex model.

58. A system according to claim 49 wherein the data generation module is further configured to prompt the user to select an input data for a complex environmental model, the input data comprising at least one of a date span, a grid, an area source, a point source, a biogenics source, a mobile source, an all merge option, a meteorology option, and a maximum number of emission layers for the meteorology option.

59. A system according to claim 49 wherein the data generation module is further configured to prompt the user to select an analysis parameter for a complex environmental model, the analysis parameter comprising at least one of a modeling type, a particular model within the modeling type, and a speciation of the particular model.

60. A system according to claim 59 wherein the data generation module is further configured to prompt the user to select a modeling type comprising at least one of a global modeling type and a regional/urban modeling type.

61. A system according to claim 60 wherein the data generation module is further configured to prompt the user to select a modeling type comprising at least one of a Global Balance Environment (GLOBE) global modeling type and a Sparse Matrix Operator Kernel Emissions (SMOKE) regional/urban modeling type.

62. A system according to claim 61 wherein the data generation module is further configured to prompt the user to select a particular model within the SMOKE regional/urban modeling type, the particular model comprising at least one of a Community Multiscale Air Quality (CMAQ) model, an Urban Airshed Model—Variable Grid (UAM-V) model, a Comprehensive Air Quality Model with Extensions (CAMx) model, a Multiscale Air Quality Simulation Platform (MAQSIP) model, a Regulatory Modeling System for Aerosols and Deposition (REMSAD) model, an Urban Airshed Model—Aerosol (UAM-AERO) model, and an Urban Airshed Model—Version 4 (UAM-IV) model.
